(19) United States
(12) Patent Application Publication
(10) Pub. No.: US 2026/0319608 A1
(43) Pub. Date: Oct. 15, 2026

(54) ACTIVE TRANSMITTER, TOUCH SENSITIVE PROCESSING APPARATUS AND METHOD, AND TOUCH SYSTEM

(71) Applicant: EGALAX_EMPIA TECHNOLOGY INC., Taipei City (TW)

(72) Inventors: Chin-Fu CHANG, Taipei City (TW); Shang-Tai YEH, Taipei City (TW)

(21) Appl. No.: 19/444,249

(22) Filed: Jan. 9, 2026

Related U.S. Application Data
(60) Provisional application No. 63/748,455, filed on Jan. 23, 2025.

(30) Foreign Application Priority Data
Dec. 5, 2025 (TW) 114147845

(51) Int. Cl. G06F 3/041

(52) U.S. Cl. CPC G06F 3/04162

(57) ABSTRACT

According to an embodiment of the present application, an active transmitter is provided. The active transmitter, comprising: multiple contact surfaces, each of the contact surfaces comprises a first driving electrode and a second driving electrode, there is a line between the first and the second driving electrodes, wherein lengths of the lines corresponding to the contact surfaces are different.

### CROSS REFERENCE TO RELATED PATENT APPLICATION

This patent application is based on a provisional patent application No. 63/748,455 filed on Jan. 23, 2025, and a Taiwan, R.O.C. patent application No. 114147845 filed on Dec. 5, 2025.

### FIELD OF THE INVENTION

The present application is related to input apparatus of touch screen or panel, especially related to active transmitter apparatus and touch sensitive processing apparatus and method thereof.

### BACKGROUND OF THE INVENTION

Touch screens are common input/output devices of modern electronic apparatus. Generally speaking, users usually input via stylus and touch board erasers. However, except for these two kinds of devices, there exists a need for a new kind of input apparatus to perform one of input methods to the touch screens so as that a touch sensitive processing apparatus of the touch screen not only be aware of a position and an orientation of the new input apparatus, but also be aware of which contact surface being used to input the touch screen.

### SUMMARY OF THE INVENTION

According to an embodiment of the present application, an active transmitter is provided. The active transmitter, comprising: multiple contact surfaces, each of the contact surfaces comprises a first driving electrode and a second driving electrode, there is a line between the first and the second driving electrodes, wherein lengths of the lines corresponding to the contact surfaces are different.

Preferably, in order to calculate a reference position of the one of the contact surfaces, wherein the active transmitter emits a first and a second driving signals via the first and the second driving electrodes of at least one of the contact surfaces, respectively, such that a touch sensitive processing apparatus of a touch panel is aware of positions of the first and the second driving electrodes on the touch panel according to the first and the second driving signals, respectively, a length of the line between the first and the second driving electrodes, and the at least one contact surfaces corresponding to the length of the line, and an orientation of the active transmitter accordingly.

Preferably, in order to distinguish the first and the second driving signals by the touch sensitive processing apparatus, wherein the first and the second driving signals are modulated according to one or any combination of following modulations: time, frequency, code, phase, and ratio of signal strength.

Preferably, in order to make the active transmitter as a toss tool, wherein the contact surfaces comprise N contact surfaces, size and shape of each of the contact surfaces are identical, the active transmitter is N-sided polyhedron, where N is a positive integer equals or larger than 4.

Preferably, in order to let the touch sensitive processing apparatus detect the active transmitter via the touch panel, the active transmitter is further configured for emitting first driving signals via the first driving electrodes of every of the contact surfaces and emitting second driving signals via the second driving electrodes of every of the contact surfaces.

Preferably, in order to saving power consumption of the active transmitter and reducing interference to the touch sensitive processing apparatus, wherein the active transmitter further comprises a sensing electrode, wherein the active transmitter is configured for emitting the first and the second driving signals after detecting, by the sensing electrode, beacon signals being periodically emitted by the touch sensitive processing apparatus.

Preferably, in order to saving power consumption of the active transmitter and reducing interference to the touch sensitive processing apparatus, wherein each of the contact surfaces comprises a sensing electrode, wherein the active transmitter is configured for emitting the first and the second driving signals via the first and the second driving electrodes of a first contact surface of the contact surfaces, respectively, after detecting, by the sensing electrode of the first contact surface, beacon signals being periodically emitted by the touch sensitive processing apparatus.

Preferably, in order to saving power consumption of the active transmitter, wherein the active transmitter further comprises an attitude sensor for sensing a first contact surface of the contact surfaces corresponding to a touch panel, wherein the active transmitter is configured to emit the first and the second driving signals only via the first and the second driving electrodes of the first contact surface, respectively.

Preferably, in order to increase the number of contact surfaces, wherein a first contact surfaces of the contact surfaces comprises a third driving electrode, wherein the active transmitter is configured for emitting driving signals via the first, the second, and the third driving electrodes of the first contact surface such that a touch sensitive processing apparatus of a touch panel is aware of positions of the first, the second, and the third driving electrodes on the touch panel according to the driving signals, respectively, and the first contact surfaces touching the touch panel.

Preferably, in order to increase the number of contact surfaces, wherein each of the contact surfaces comprises P driving electrodes, where P is a positive integer larger than 2, wherein the active transmitter further comprises an interface module configured for receiving a configuration command for setting shapes being formed by Q driving electrodes capable of emitting driving signals of the contact surfaces, wherein the shapes of the contact surfaces are different, where Q is a positive integer equals to or smaller than P.

According to an embodiment of the present application, a touch sensitive processing apparatus is provided for connecting to a touch panel for detecting a first active transmitter, wherein the touch panel comprising multiple first touch electrodes in parallel to a first axis and multiple second touch electrodes in parallel a second axis, each of the first electrodes intersects with the second touch electrodes, wherein the touch sensitive processing apparatus comprising: an interconnection network module for connecting to the first and the second touch electrodes, respectively; a sensing circuit module for connecting to the interconnection module for receiving first driving signals and second driving signals from a first contact surface of multiple contact surfaces of the first active transmitter via the first and the second touch electrodes, respectively; a processor module for executing instructions stored in non-volatile memory for realizing: calculating a first and a second positions of the first and the second driving electrodes on the touch panel according to the first and the second driving signals, respectively, calculating a length of a first line between the first and the second positions, and finding the first contact surfaces among the contact surfaces corresponding to the length of the first line in a data table; and an interface module for reporting the first contact surfaces of the first active transmitter to a host.

Preferably, in order to report a reference position where the first active transmitter on the touch panel, wherein the processor module is further configured for calculating a first reference position of the first active transmitter on the touch panel according to a reference position calculation method corresponding to the first contact surface and the first and the second positions; and the interface module is further configured for reporting the first reference position of the first active transmitter to the host.

Preferably, in order to report an orientation of the first active transmitter on the touch panel, wherein the processor module is further configured to calculate an orientation of the first active transmitter on the touch panel according to a configuration of the first and the second driving electrodes corresponding to the first contact surface and the first and the second positions, and wherein the interface module is further configured for reporting the orientation of the first active transmitter to the host.

Preferably, in order to distinguish the first and the second driving signals by the touch sensitive processing apparatus, wherein the first and the second driving signals are modulated according to one or any combination of following modulations: time, frequency, code, phase, and ratio of signal strength, wherein the processor module is configured to demodulate the received first and the second driving signals according to the modulations.

Preferably, in order to saving power consumption of the active transmitter and reducing interference to the touch sensitive processing apparatus, wherein the touch sensitive processing apparatus further comprises a driving circuit module for connecting the interconnection network module to periodically emit beacon signals via at least one of the first touch electrode or at least one of the second touch electrode in a first signal period, wherein the sensing circuit module is configured to periodically sense the first and the second driving signals in a second signal period after the first signal period.

Preferably, in order to increase the number of contact surfaces, wherein the first contact surface further comprises a third driving electrode, wherein the active transmitter is configured for emitting driving signals via the first, the second, and the third driving electrodes of the first contact surface, wherein the sensing circuit module is configured to sense the driving signals, wherein the processor module is configured to calculate positions of the first, the second, and the third driving electrodes on the touch panel according to the driving signals, respectively; and to determine that the first contact surface touching the touch panel according to the data table.

Preferably, in order to increase the number of contact surfaces, wherein the data table further comprises a shape being formed by the first, the second, and the third driving electrodes.

Preferably, in order to increase the number of active transmitters being used simultaneously, wherein the sensing circuit module for connecting to the interconnection module for receiving third driving signals and fourth driving signals emitted from the first driving electrode and the second electrode of a second contact surface of multiple contact surfaces of a second active transmitter via the first and the second touch electrodes, respectively; wherein the processor module is further configured for calculating a third and a fourth positions of the first and the second driving electrodes on the touch panel according to the third and the fourth driving signals, respectively, calculating a length of a second line between the third and the fourth positions, and finding the second contact surface among the contact surfaces corresponding to the length of the second line in the data table; and wherein the interface module is further configured for reporting second first contact surfaces of the second active transmitter to the host, wherein the first and the second active transmitters are in the same kind.

According to an embodiment of the present application, a touch system is provided. The touch system comprises the first active transmitter, the touch panel, the touch sensitive processor, and the host.

According to an embodiment of the present application a touch sensitive processing method for detecting a first active transmitter via a touch panel is provided. The touch panel comprising multiple first touch electrodes in parallel to a first axis and multiple second touch electrodes in parallel a second axis, each of the first electrodes intersects with the second touch electrodes. The touch sensitive processing method comprising: sensing first and second driving signals via first and second touch electrodes of the touch panel, wherein the first driving signals are emitted from a first driving electrode of the first active transmitter and the second driving signals are emitted from a second driving electrode of the first active transmitter; calculating a first position and a second position according to the sensed first driving signals and the sensed driving signals, respectively, wherein the first and the second positions are corresponding to the first and the second driving electrodes, respectively; calculating a length of a line between the first and the second positions; finding a first contact surface among multiple contact surfaces of the first active transmitter in a data table according to the length of the line, wherein the contact surface comprises the first and the second driving electrodes; and reporting to a host that the first contact surface of the first active transmitter touching the touch panel.

Preferably, in order to report a reference position where the first active transmitter on the touch panel, wherein the touch sensitive processing method further comprises: calculating a first reference position of the first active transmitter on the touch panel according to a reference position calculation method corresponding to the first contact surface and the first and the second positions; and reporting the first reference position of the first active transmitter to the host.

Preferably, in order to obtain an orientation of the active transmitter with respect to the touch panel, wherein the touch sensitive processing method further comprises: calculating an orientation of the first active transmitter according to a configuration of the first and the second driving electrodes corresponding to the first contact surface and the first and the second positions; and reporting the orientation of the first active transmitter to the host.

Preferably, in order to distinguish the first and the second driving signals by the touch sensitive processing apparatus, wherein the first and the second driving signals are modulated according to one or any combination of following modulations: time, frequency, code, phase, and ratio of signal strength, wherein the step of calculating the first position and a second position includes demodulations according to the modulations.

Preferably, in order to saving power consumption of the active transmitter and reducing interference to other kinds of touch sensing, wherein the touch sensitive processing method further comprises periodically emitting beacon signals via at least one of the first touch electrode or at least one of the second touch electrode in a first signal period; and periodically sensing the first and the second driving signals in a second signal period after the first signal period.

Preferably, in order to increase the number of contact surfaces, wherein the active transmitter is configured for emitting driving signals via the first, the second, and the third driving electrodes of the first contact surface, wherein the touch sensitive processing method further comprises sensing the driving signals; calculating positions of the first, the second, and the third driving electrodes on the touch panel according to the driving signals, respectively; and determining that the first contact surface touching the touch panel according to the data table.

Preferably, in order to increase the number of contact surfaces, wherein the data table further comprises a shape being formed by the first, the second, and the third driving electrodes.

Preferably, in order to increase the number of active transmitters being used simultaneously, the touch sensitive processing method further comprises: receiving third driving signals and fourth driving signals emitted from the first driving electrode and the second electrode of a second contact surface of multiple contact surfaces of a second active transmitter via the first and the second touch electrodes, respectively; calculating a third and a fourth positions of the first and the second driving electrodes on the touch panel according to the third and the fourth driving signals, respectively; calculating a length of a second line between the third and the fourth positions; finding the second contact surfaces among the contact surfaces corresponding to the length of the second line in the data table; and reporting second first contact surfaces of the second active transmitter to the host, wherein the first and the second active transmitters are in the same kind.

According to one or more active transmitters provided by the present application, multiple parameters can be simultaneously inputted into a touch panel or a touch screen. Thus, the touch sensitive processing apparatus of the touch panel is able to aware of positions and orientations of the one or more active transmitters. Moreover, it can further determine that which contact surfaces of each of the active transmitters are used to input into the touch panel and corresponds to which one of different roles, numbers, characters, or pieces of games.

### BRIEF DESCRIPTION OF THE DRAWINGS

The advantages and spirit related to the present invention can be further understood via the following detailed description and drawings.

FIG. 1 is a block diagram of a touch system 9900 of an embodiment of the present application.

FIG. 2 illustrates a block diagram of an active transmitter apparatus 9800 in accordance with an embodiment of the present application.

FIG. 3 illustrates a diagram of the active transmitter apparatus 9800 in accordance with an embodiment of the present application.

FIG. 4 illustrates a diagram of a contact surface 310 of the active transmitter apparatus 9800 in the embodiment as shown in FIG. 3.

FIG. 5 illustrates a diagram of a detection image of the touch screen 9920 in accordance with an embodiment of the present application.

FIG. 6 depicts a timing diagram of beacon signals and signals transmitted by the active transmitter in accordance with an embodiment of the present application.

FIG. 7 depicts a timing diagram of beacon signals and signals transmitted by the active transmitter in accordance with another embodiment of the present application.

FIG. 8 are diagrams illustrating two electrodes in each of contact surfaces.

FIG. 9 is a diagram depicts a contact surface with three driving electrodes in accordance with an embodiment of the present application.

FIG. 10 is a timing diagram depicting beacon signals and signals transmitted by the active transmitter according to another embodiment of the present application.

FIG. 11 is a timing diagram depicting beacon signals and signals transmitted by the active transmitter according to another embodiment of the present application.

FIG. 12 shows a block diagram of a variant of the active transmitter apparatus 9800 as shown in FIG. 2.

FIG. 13 shows a block diagram of a variant of the active transmitter apparatus 9800 as shown in FIG. 2.

FIG. 14 depicts a flowchart diagram of a touch sensitive processing method 1400 in accordance with an embodiment of the present application.

### DETAILED DESCRIPTION OF THE PREFERRED EMBODIMENT

Some embodiments of the present application are described in detail below. However, in addition to the description given below, the present invention can be applicable to other embodiments, and the scope of the present invention is not limited by such rather by the scope of the claims. Moreover, for better understanding and clarity of the description, some components in the drawings may not necessary be drawn to scale, in which some may be exaggerated related to others, and irrelevant. If no relation of two steps is described, their execution order is not bound by the sequence as shown in the flowchart diagram.

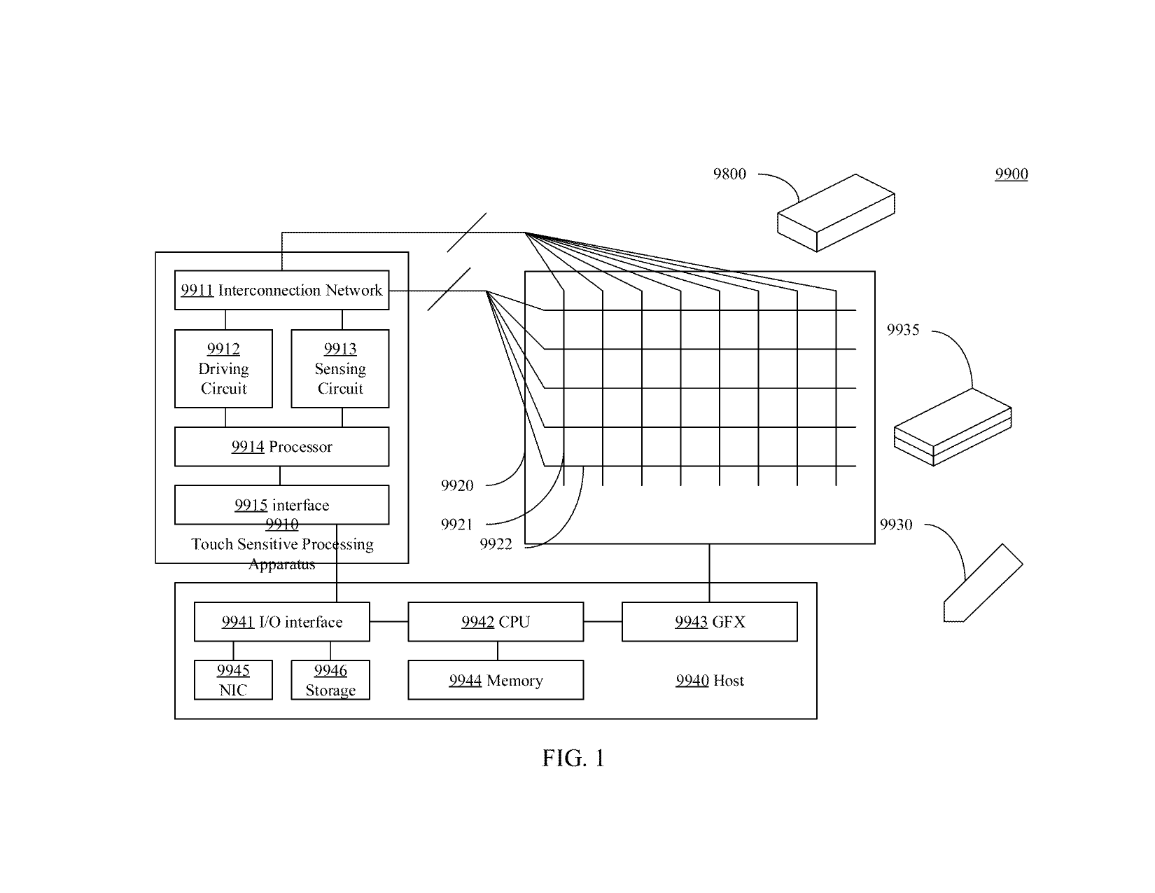

Please refer to FIG. 1, which is a block diagram of a touch system 9900 of an embodiment of the present application. The touch system 9900 may be common desktop, laptop, tablet computers, industrial control computers, smartphones or any other kind of computers having touch sensitive functionality.

The touch system 9900 may comprise a touch sensitive processing apparatus 9910, a touch panel or screen 9920 connected to the touch sensitive processing apparatus, and a host 9940 connected to the touch sensitive processing apparatus. The touch system 9900 may further comprises one or more stylus 9930 and/or touch board erasers 9935. In the following specification of the present application, the touch panel or screen 9920 may be referred to as touch screen 9920. However, in the embodiment lack of display functionality, person having ordinary skill in the art can understand that the touch screen as recited is touch panel.

The touch screen 9920 may comprise multiple first electrodes 9921 in parallel to a first axis and multiple second electrodes 9922 in parallel to a second axis. The first electrodes 9921 may intersect with the second electrodes 9922 in order to form multiple sensing points or sensing areas. Equivalently, the second electrodes 9922 may intersect with the first electrodes 9921 in order to form multiple sensing points or sensing areas. In some embodiments of the present application, the first electrodes 9921 may be referred as first touch electrodes 9921 and the second electrodes 9922 may be referred as second touch electrodes 9922. The first electrodes 9921 and the second electrodes 9922 may be collectively referred as touch electrodes. In some embodiments, the first electrodes 9921 and the second electrodes 9922 are made by transparent material. When applicable to the touch screen 9920 of some embodiments, the first electrodes 9921 and the second electrodes 9922 may be disposed in one electrode layer. Conductive plates of each one of the first electrodes 9921 or the second electrodes 9922 may be connected by bridging. The first electrodes 9921 and the second electrodes 9922 may be disposed at different overlapping electrode layers. Unless described specifically, the present application may be applied to the embodiments having one or more electrode layers. The first axis and the second axis are perpendicular in most cases. However, the present application does not limit that the first axis and the second axis are perpendicular. In one embodiment, the first axis may be a horizontal axis or a pixel refreshing axis of the touch screen 9920.

The touch sensitive processing apparatus 9910 may comprise following hardware circuit modules: an interconnection network module 9911, a driving circuit module 9912, a sensing circuit module 9913, a processor module 9914, and an interface module 9915. The touch sensitive processing apparatus 9910 may be implemented inside a single integrated circuit which may include one or more chips. It may use multiple integrated circuits and an interconnected circuit board carried the multiple integrated circuits to realize the touch sensitive processing apparatus 9910. The touch sensitive processing apparatus 9910 may be implemented in single integrated circuits with the host 9940. The present application does not limit how to implement the touch sensitive processing apparatus 9910.

The interconnection network module 9911 is configured to connect each of the multiple first electrodes 9921 and/or the multiple second electrodes 9922 of the touch screen 9920. The interconnection network module 9911 may follow control command of the processor module 9914 for connecting the driving circuit module 9912 and any one or more touch electrodes and for connecting the sensing circuit module 9913 and any one or more touch electrodes. The interconnection network module 1211 may include a combination of one or more multiplexers (MUX) to realize functions.

The driving circuit module 9912 may comprise clock generator, frequency divider, frequency multiplier, phase lock loop, power amplifier, DC-DC voltage converter, regulator and/or filter, which is configured to provide driving signal to any one or more touch electrodes via the interconnection network module 9911 according to control commands of the processor module 9914. The driving signal may be modulated by kinds of analog or digital modulations for carrying some messages. The modulations include but not limit to frequency modulation (FM), phase modulation, amplitude modulation, dual sideband modulation (DSB), single sideband module (SSB-AM), vestigial sideband modulation, amplitude shift keying (ASK), phase shift keying (PSK), quadrature amplitude modulation (QAM), frequency shift keying (FSK), continuous phase modulation (CPM), code division multiple (CDMA), time division multiple access (TDMA), orthogonal frequency division multiplexing (OFDM), pulse width modulation (PWM) and etc. The driving signal may include one or more square waves, sinuous waves or any modulated waves. The driving circuit module 9912 may include one or more channel. Each channel may be connected to any one or more touch electrodes via the interconnection network module 9911.

The sensing circuit module 9913 may comprise integrator, sampler, clock generator, frequency divider, frequency multiplier, phase lock loop, power amplifier, operational amplifier, multiplier, DC-DC voltage converter, regulator and/or filter, which is configured to sense on any one or more touch electrodes and second button electrodes via the interconnection network module 9911 according to control commands of the processor module 9914. When the touch signal is transmitted from one of the touch electrodes, another touch electrode may induce the touch signal. And the sensing circuit module 9913 may demodulate the induced touch signal by another touch electrode in accordance with the modulation method performed on the driving signal by the driving circuit module 9912 in order to restore the messages carried by the driving signal. The sensing circuit module 9913 may include one or more channels. Each channel may be connected to any one or more touch electrodes via the interconnection network module 9911. At the same time, each channel may simultaneously perform sensing and demodulation.

In one embodiment, the driving circuit module 9912 and the sensing circuit module 9913 may include analog front-end (AFE) circuits. In another embodiment, in additional to the AFE circuits, the driving circuit module 9912 and the sensing circuit module 9913 may include digital back-end (DBE) circuits. If the driving circuit module 9912 and the sensing circuit module 9913 include only the AFE circuits, the DBE circuits may be implemented in the processor module 9914.

The processor module 9914 may include a digital signal processor for connecting the AFE circuits or the DBE circuits of the driving circuit module 9912 and the sensing circuit module 9913, respectively. The processor module 9914 may include an embedded processor, non-volatile memories and volatile memories. Normal or real-time operating system (OS) and their application programs may be stored in the non-volatile memories. The OS and the application programs include multiple instructions and data. The processor (including the embedded processor and the digital signal processor) may execute the instructions for controlling other modules including the interconnection network module 9911, the driving circuit module 9912, the sensing circuit module 9913 and the interface module 9915 of the touch sensitive processing apparatus 9910. For examples, the processor module 9914 may comprises processors widely adopted in the industry such as 8051 series, Intel i960 series, ARM Cortex-M series and etc. The present application does not limit types and numbers of processor cores included in the processor module 9914.

The instructions and data may be used to implement each of steps mentioned in the present application and flows and methods constructed by the steps. Some instructions may be executed independently inside the processor module 9914, for examples, arithmetic and log operation instructions. Other instructions may be used to control other circuits of the touch sensitive processing apparatus 9910. These instructions may include input/output interfaces of the processor module 9914 to control other circuits. Other circuits may provide information via the input/output interface of the processor module 9914 to the OS and/or application programs executed by the processor module 9914. Persons having ordinary skill in the art should have common knowledge of computer organization and architecture which enabling them to understand that the flows and methods provided by the present application can be realized by the circuits and the instructions.

The interface module 9915 may include kinds of serial or parallel bus, such as universal serial bus (USB), I²C, peripheral component interconnect (PCI), PCI-Express, IEEE 1394 and other industrial standard input/output interface. The touch sensitive processing apparatus 9910 connects to the host 9940 via the interface module 9915.

The touch system 9900 may comprise one or more styli 9930 and/or touch board erasers 9935. The stylus 9930 and touch board eraser 9935 may be transmitters which emit electrical signals. The transmitters may include active transmitter which actively emits electrical signals or passive transmitters which emit electrical signals in response to external electrical signals. The stylus 9930 and touch board eraser 9935 may comprise one or more electrodes which is configured to receive electrical signals from the touch screen 9920 synchronously or asynchronously, or to transmit electrical signals to the touch screen 9920 synchronously or asynchronously. The electrical signals may be modulated according to one or more of the aforementioned modulation methods.

The stylus 9930 or touch board eraser 9935 may be conductor which is configured to transmit driving signals or to be grounded via user’s hand or body. The stylus 9930 or touch board eraser 9935 may be physically or wirelessly connected to an I/O interface 9941 of the host 9940 or any other interfacing circuits of the I/O interface 9941.

The touch sensitive processing apparatus 9910 may detect one or more external objects such as fingers, palms, or passive styli 9930 or touch board erasers 9935, or active styli 9930 or touch board erasers 9935 emitting electrical signals via the touch screen 9920. The touch sensitive processing apparatus 9910 may utilize mutual-capacitance sensing or self-capacitance sensing to detect external conductive objects. The styli 9930 or touch board erasers 9935 and touch sensitive processing apparatus 9910 may use the aforementioned modulation and demodulation methods to transmit message via the electrical signals. The touch sensitive processing apparatus 9910 may detect one or more positions where the styli 9930 or touch board erasers 9935 touch or approach the touch screen 9920, status or sensors (pressure sensor or button) onboard the stylus 9930 or touch board eraser 9935, orientation angle or inclination angle of the stylus 9930 or touch board eraser 9935 with respect to the touch screen 9920 etc. according to the electrical signals.

The host 9940 is a main apparatus for controlling the electronic system 9900. It may comprise an input/output interface module 9941 for connecting the interface module 9915, a central processing unit (CPU) module 9942, a graphics processor module 9943, a memory module 9944 connects to the CPU module 9942, a network interface module 9945 and a storage module 9946 connecting to the input/output interface module 9941.

The storage module 9946 comprises non-volatile memory. Common examples are hard disks, electronic erasable rewritable read only memory (EEPROM), or flash memory. The storage module 9946 may store normal operating system and application programs executable under the operating system. The network interface module 9945 may comprise wired or wireless hardware network interface. The network interface module 9945 may be compliant to common industrial standards such as IEEE 802.11 Wireless Local Area Network, IEEE 802.3 Local Area Network, 3G, 4G and/or 5G wireless telecommunication standards, Bluetooth wireless communication standards, etc.

The CPU module 9942 may directly or indirectly connects to the input/output interface module 9941, the graphics processor module 9943, the memory module 9944, the network interface module 9945 and the storage module 9946. The CPU module 9942 may comprise one or more processor or processor cores. Common processors may include Intel, AMD, VIA’s x86 and x64 instruction set architecture (ISA) processors, Apple, Qualcomm, MediaTek’s ARM ISA processors, or any other types of complex instruction set computer (CISC) or reduced instruction set computer (RISC) processors. The OS and application programs include multiple instructions and data corresponding to the instruction set. By executing these instructions, the CPU module 9942 is able to control other circuits of the touch system 9900.

The optional graphics processor (GPU) module 9943 is usually configured to handle computations with respect to graphics outputs. The graphics processor module 9943 may connect to the touch screen 9920 for controlling outputs of the touch screen 9920. In some applications, the host 9940 may have the CPU module 9942 execute the computations with respect to graphics outputs, without dedicated handling of the graphics processor module 9943.

The host 9940 may comprise components or apparatus not shown in FIG. 1, for example, audio input/output interface, keyboard input interface, mouse input interface, track-ball input interface and/or any other hardware circuits. Persons having ordinary skill in the art should have common knowledge of computer organization and architecture. They can understand the electronic system 9900 disclosed by the present application is exemplary. Parts regarding to the inventive feature provided by the present application should be referred to the specification and the claims.

As shown in FIG. 1, the touch sensitive processing apparatus 9910 may detect one or more active transmitter apparatuses’ positions and/or orientations. If the active transmitter apparatus 9800 comprises multiple contact surfaces or multiple roles, the touch sensitive processing apparatus may detect which one of the contact surfaces or which one of the roles of the active transmitter apparatus approaching or touching the touch screen 9920.

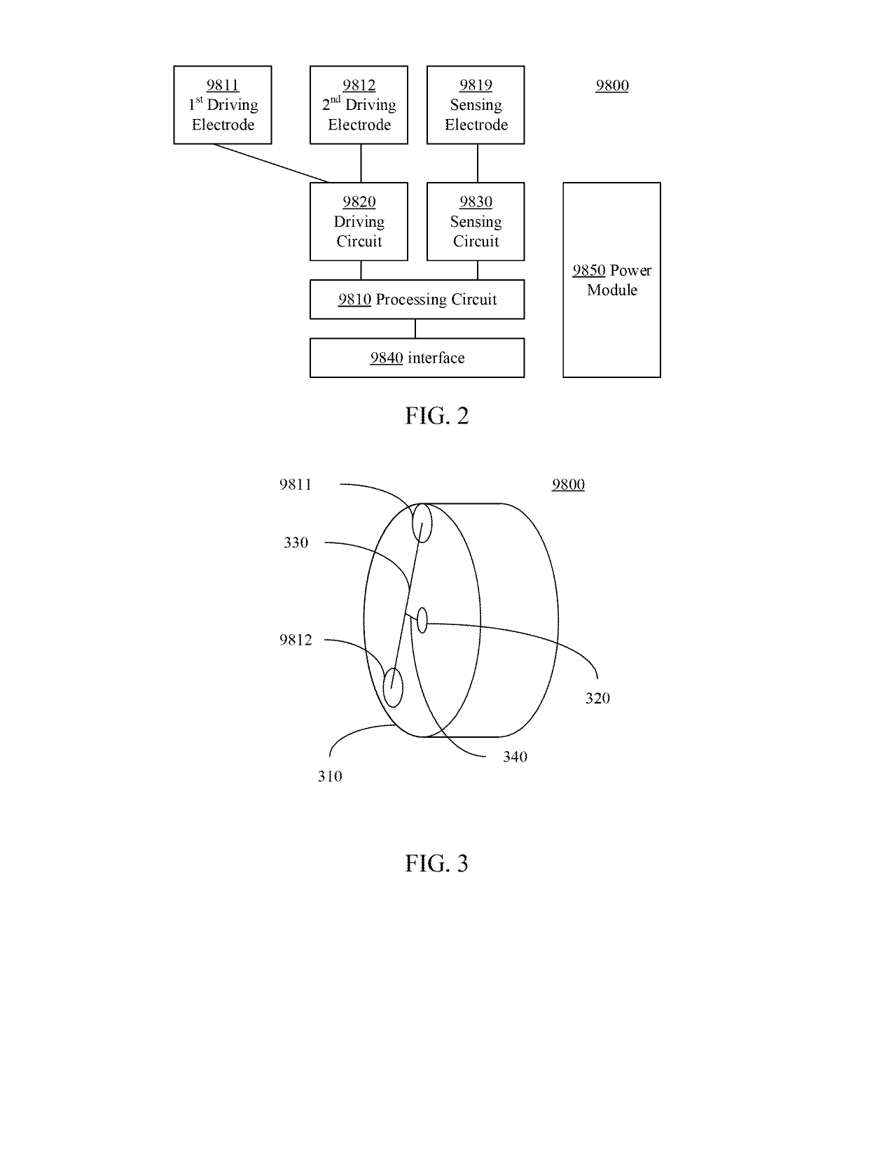

Please refer to FIG. 2, which illustrates a block diagram of an active transmitter apparatus 9800 in accordance with an embodiment of the present application. The active transmitter apparatus 9800 may comprise processing circuits 9810, a driving circuit module 9820, a sensing circuit module 9830, an optional interface module 9840, a power source module 9850, a first driving electrode 9811, a second driving electrode 9812 and a sensing electrode 9819.

The driving circuit module 9820 may directly or indirectly connects to the first driving electrode 9811 and the second driving electrode 9812. The embodiments of the driving circuit module 9820 may be applicable to the description of the driving circuit module 9912 of the touch sensitive processing apparatus 9910. The sensing circuit module 9830 may directly or indirectly connects to the sensing electrode 9819. The sensing circuit module 9830 may be applicable to the description of the sensing circuit module 9913 of the touch sensitive processing apparatus 9910.

The power source module 9850 is configured to supply power to the active transmitter apparatus 9800. For examples, the power source module 9850 may include a battery, a rechargeable battery and its charging module, and/or super capacitor and its charging module. When the power source module 9850 comprises the rechargeable battery or the super capacitor, it may connect to external power supplier via the interface module 9840 for receiving power to charge the rechargeable battery or the super capacitor. The interface module 9840 may comprise wired and/or wireless charging interfaces. The interface module 9840 may be customized proprietary interface or may be compatible with industrial standard charging interfaces.

In one embodiment, the processing circuits 9810 may comprise customized processing circuits, such as FPGA or some kinds of tailored made processing logic circuitries. In an alternative embodiment, the processing circuit 9810 may include microprocessor. In the present application, the processing circuits 9810 may be applicable to the description of the processor module 9914 of the touch sensitive processing apparatus 9910.

In one embodiment, the active transmitter apparatus 9800 may comprise one or more contact surfaces for touching the touch screen 9920. The first driving electrode 9811, the second driving electrode 9812, and/or the sensing electrode 9819 may be disposed on top of the at least one contact surface. In one variant, the first driving electrode 9811, the second driving electrode 9812, and/or the sensing electrode 9819 may be disposed internally under one of the contact surfaces.

In one embodiment, the active transmitter apparatus 9800 may omit the sensing electrode 9819 and add an interconnection network module. The interconnection network module may be configured to connect the first driving electrode 9811 and the second driving electrode 9812 to the driving circuit module 9820 and the sensing circuit module 9830, respectively, according to instructions of the processing circuits 9810. For example, during a first time period, the second driving electrode 9912 may be connected to the driving circuit module 9820 via the interconnection network module. During a second time period, the second driving electrode 9912 may be connected to the sensing circuit module 9830 via the interconnection network module. During a first time period, the first driving electrode 9811 may be connected to the driving circuit module 9820 via the interconnection network module. During the second time period, the first driving electrode 9911 may be connected to the sensing circuit module 9830 via the interconnection network module.

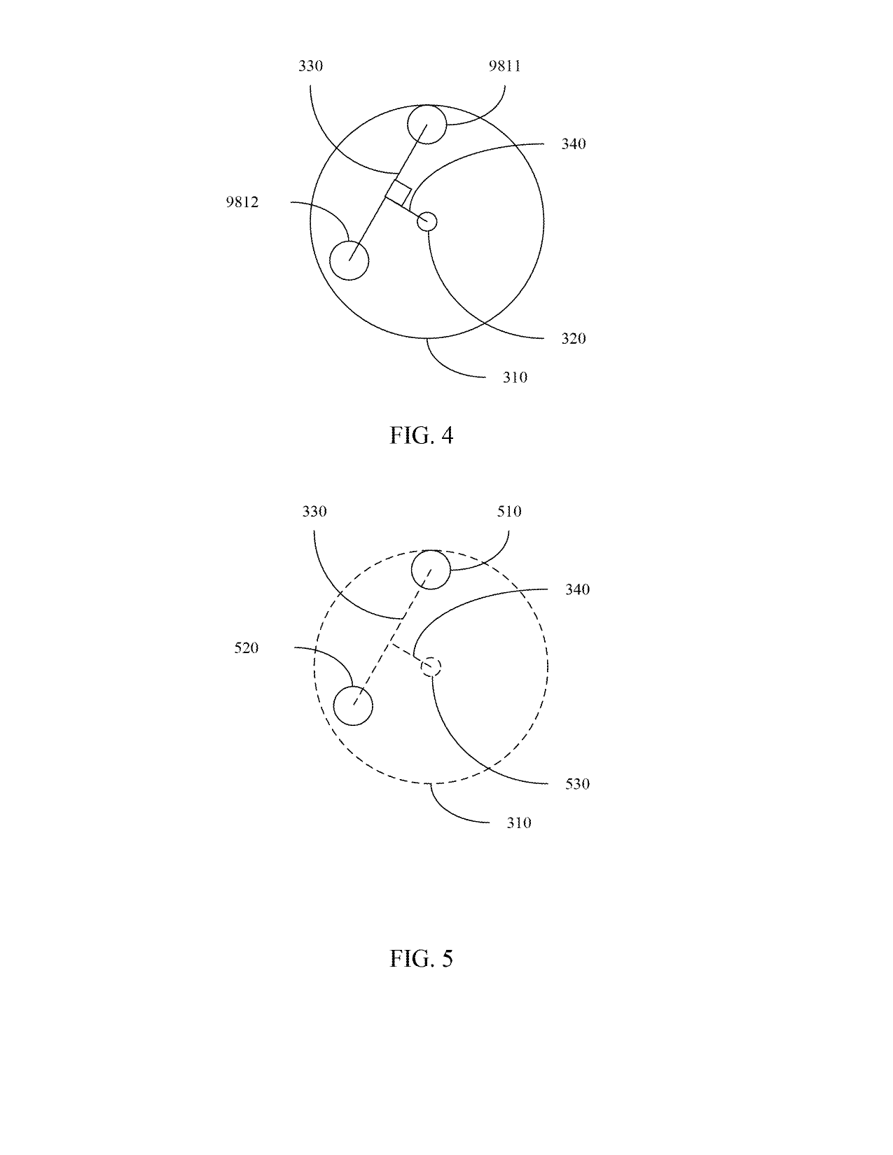

Please refer to FIG. 3, which illustrates a diagram of the active transmitter apparatus 9800 in accordance with an embodiment of the present application. Please refer to FIG. 4, which illustrates a diagram of a contact surface 310 of the active transmitter apparatus 9800 in the embodiment as shown in FIG. 3. The active transmitter apparatus 9980 may be a cylinder. The bottom face of the cylinder is the contact surface 310 which is configured for touching the touch screen 9920. The top face of the cylinder may be used to mark the active transmitter apparatus 9800. The cylinder may be designed to be waterproof and dustproof. The modules as shown in FIG. 2 may be installed inside the cylinder.

In one embodiment, the active transmitter apparatus 9800 may be used as a piece of chess. For examples, it may be a black piece or a white piece of Go, or any other kinds of pieces in Chinese chess, chess, and Shogi. In an alternative embodiment, the active transmitter apparatus 9800 may be a piece capable of indicating a direction.

On the contact surface or in the interior near the surface, there are the first driving electrode 9811, the second driving electrode 9812, and/or the sensing electrode 9819. A line 330 is formed between a central point of the first driving electrode 9811 and a central point of the second driving electrode 9812. The length of the line 330 is fixed. The touch sensitive processing apparatus 9910 is aware of the length of the line 330 in advanced. Similarly, a distance between the central point 320 of the contact surface and the central point of the first driving electrode 9811 is predetermined. A distance between the central point 320 of the contact surface and the central point of the second driving electrode 9812 is also predetermined. The length of a normal line 340 between the central point 320 and the line 330 is well known, too. The touch sensitive processing apparatus 9910 is aware of the length of the normal line 340 in advanced.

In one embodiment, the driving circuit module 9912 of the touch sensitive processing apparatus 9910 transmits beacon signals via one or more first electrodes 9921. The sensing circuit module 9830 of the active transmitter apparatus 9800 senses the beacon signals via the sensing electrode 9819 and notifies the processing circuit 9819. In one embodiment, the processing circuit 9810 has the driving circuit module 9820 emits signals via the first driving electrode 9811 and the second driving electrode 9812 sequentially in a time-sharing manner. The sensing circuit module 9913 of the touch sensitive apparatus 9910 may be able to sense the signals via the one or more second electrodes 9922 and/or one or more first electrodes 9921 sequentially in the time-sharing manner. Consequently, the processor module 9914 of the touch sensitive processing apparatus 9910 can calculate the central point of the first driving electrode 9811 and the central point of the second driving electrode 9812.

In some embodiments, the processing circuit 9810 has the driving circuit module 9820 simultaneously transmit signals via the first driving electrode 9811 and the second driving electrode 9812 with different frequencies, respectively. In some alternative embodiments, the processing circuit 9810 has the driving circuit module 9820 simultaneously transmit signals via the first driving electrode 9811 and the second driving electrode 9812 with different codes, respectively. For examples, the signals may be encoded by different pseudo random numbers. The sensing circuit module 9913 of the touch sensitive processing apparatus 9910 may be able to detect the signals with different frequencies or the signals encoded with different pseudo random number such that the central point of the first driving electrode 9811 and the central point of the second driving electrode 9812 can be calculated consequently.

Although in abovementioned embodiments, signal transmission mechanisms like time-division, frequency-division, and code-division are enumerated, person having ordinary skill in the art can understand that there exist more kinds of multiplexing signal transmission mechanisms so as that the sensing circuit module 9913 of the touch sensitive processing apparatus 9910 may be able to detect the central point of the first driving electrode 9811 and the central point of the second driving electrode 9812, respectively.

After the central point of the first driving electrode 9811 and the central point of the second driving electrode 9812 are aware, the processor module 9914 is able to calculate a distance between these two central points. When the length of the line 330 matches the calculated distance between these two central points, the processor module 9914 can determine that the contact surface 310 of the active transmitter apparatus 9800 touches the touch screen 9920. Next, the processor module 9914 may calculate the central point 330 of the contact surface 310 and the orientation of the active transmitter apparatus 9800.

Please refer to FIG. 5, which illustrates a diagram of a detection image of the touch screen 9920 in accordance with an embodiment of the present application. As indicated, the touch sensitive processing apparatus 9910 detect the central point 510 of the first driving electrode 9811 and the central point 520 of the second driving electrode 9812 by the sensing circuit module 9913. Based on the well-known central points 510 and 520, it is determined that the contact surface 310 of the active transmitter apparatus 9800 touches the touch screen 9920. Moreover, the central point 330 of the contact surface 310 and the orientation of the active transmitter apparatus 9800 can be determined further.

Person having ordinary skill in the art can understand that the circular contact surface 310 as shown in FIGS. 3-5 is just one of the examples. The contact surface 310 may be designed as other kinds of shapes such as regular N-gon, ellipse, parallelogram, trapezoid etc., where N is an integer larger than 2. The central point 330 of the contact surface 310 may be a representative point of the contact surface 310, which may not be the center, the center of gravity, or centroid of the contact surface 310. The touch sensitive processing apparatus 9910 may report a position of the representative point of the active transmitter apparatus 9800 to the host 9940.

The contact surface 310 as shown in FIGS. 3-5 does not show the sensing electrode 9819. Person having ordinary skill in the art can understand that the one or more sensing electrode 9819 may be located at any location of contact surface 310, e.g., at the representative point, the center, the center of gravity, or centroid of the contact surface 310, for well receiving the beacon signals.

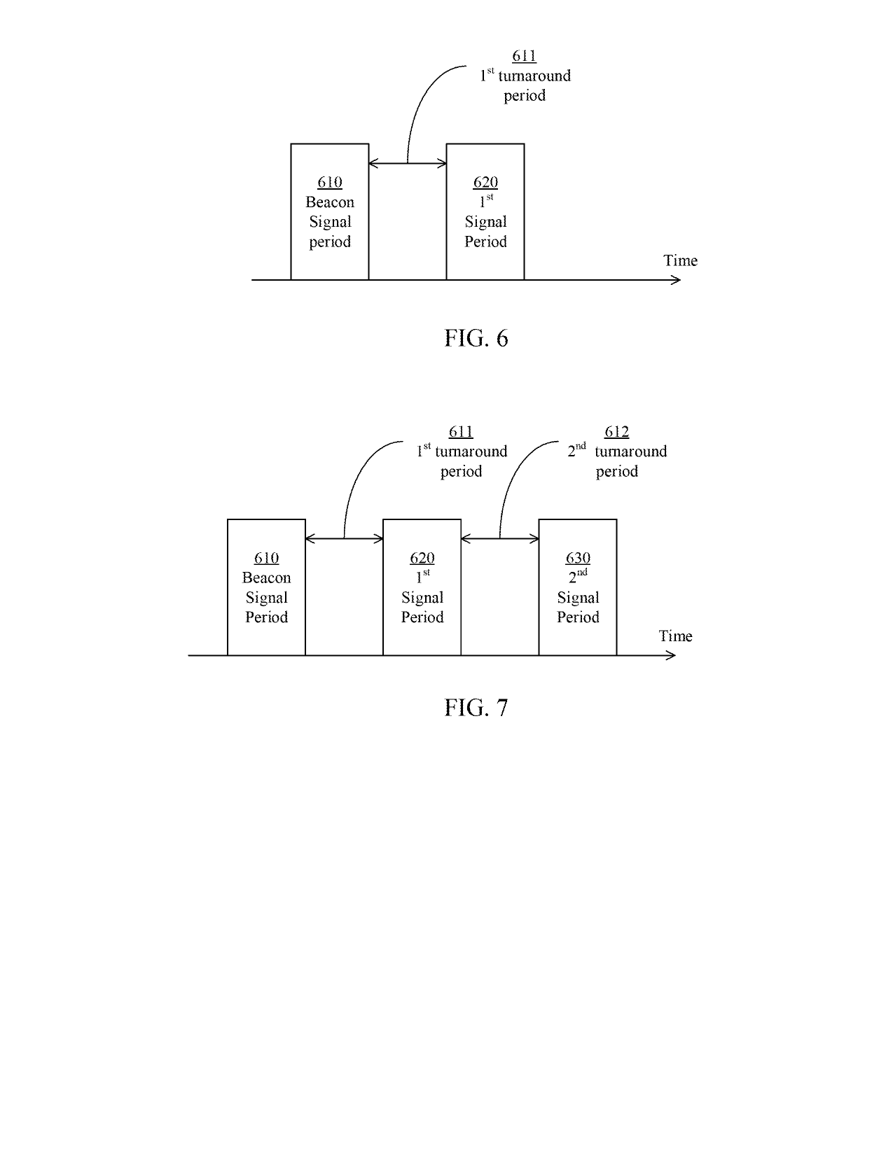

Please refer to FIG. 6, which depicts a timing diagram of beacon signals and signals transmitted by the active transmitter in accordance with an embodiment of the present application. In one period, the touch sensitive processing apparatus 9910 transmits beacon signals via at least one touch electrode of the touch screen 9920 during a beacon signal time period 610. When the active transmitter apparatus 9800 which touches the touch screen 9920 receives the beacon signals, it would transmit frequency-division, code-division, or any other kinds of modulated signals via the first driving electrode 9811 and the second driving electrode 9812 simultaneously during a first transmitter signal time period 620. Thus, the touch sensitive processing apparatus 9910 can detect the central point 510 of the first driving electrode 9811 and the central point 520 of the second driving electrode 9812 and determine the central point 330 of the contact surface 310 of the active transmitter apparatus 9800 and the orientation of the active transmitter apparatus 9800. In between the beacon signal time period 610 and the first transmitter signal time period 620, there may exist a first transition period 611 which allows the active transmitter apparatus 9800 have enough time to transit from receiving to transmitting.

Please refer to FIG. 7, which depicts a timing diagram of beacon signals and signals transmitted by the active transmitter in accordance with another embodiment of the present application. During one period, the touch sensitive processing apparatus 9910 transmits beacon signals via at least one touch electrode of the touch screen 9920 during a beacon signal time period 610. When the active transmitter apparatus 9800 which touches the touch screen 9920 receives the beacon signals, it would transmit signals via the first driving electrode 9811 during a first transmitter signal time period 620 and transmit signals via the second driving electrode 9812 during a second transmitter signal time period 630. Thus, the touch sensitive processing apparatus 9910 can detect the central point 510 of the first driving electrode 9811 and the central point 520 of the second driving electrode 9812 during the first transmitter signal time period 620 and the second transmitter signal time period 630, respectively. Moreover, it can further determine the central point 330 of the contact surface 310 of the active transmitter apparatus 9800 and the orientation of the active transmitter apparatus 9800. In between the beacon signal time period 610 and the first transmitter signal time period 620, there may exist a first transition period 611 which allows the active transmitter apparatus 9800 have enough time to transit from receiving to transmitting. In between the first transmitter signal time period 620 and the second transmitter signal time period 630, there may exist a second transition period 612 which allows the active transmitter apparatus 9800 have enough time to transit between two receiving.

Person having ordinary skill in the art can understand that although in the embodiment as shown in FIG. 6, two different driving electrodes are used to emit two different modulated signals during the same first transmitter signal time period 620, the active transmitter apparatus 9800 may include N driving electrodes to emit N modulated signals from the N driving electrodes, respectively, during the same first transmitter signal time period 620, where N is a positive integer equals to or larger than 2. Although in the embodiment as shown in FIG. 7, two different driving electrodes are used to emit two signals during the first transmitter signal time period 620 and the second transmitter signal time period 630, respectively, in a time-sharing manner, the active transmitter apparatus 9800 may include N driving electrodes to emit signals from the N driving electrodes, respectively, during the N first transmitter signal time periods, where N is a positive integer equals to or larger than 2.

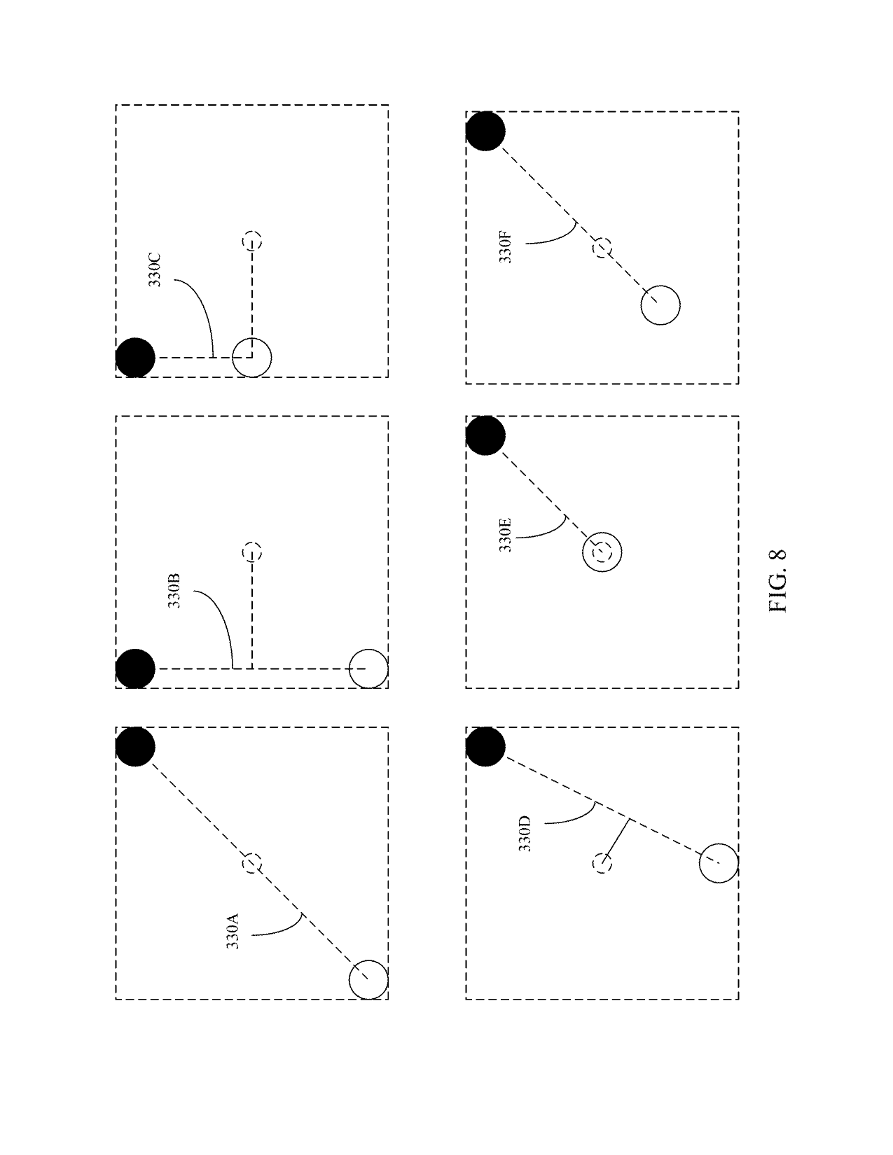

Please refer to FIG. 8, which are diagrams illustrating two electrodes in each of contact surfaces. In some examples, the active transmitter apparatus 9800 may comprise multiple contact surfaces. When different contact surface touches the touch screen 9920, the touch sensitive processing apparatus 9910 would treat it as different kinds of pieces or roles. For example, one kind of active transmitter apparatus 9800 with six contact surfaces may be functioned as a dice with six faces. Each of contact surfaces has different arrangements of driving electrodes. When an use tosses the active transmitter apparatus 9800 on the touch screen 9920, the touch sensitive processing apparatus 9910 can determine which one of the contact surfaces touches the touch screen 9920 based on the different arrangements of driving electrodes. Next, the active transmitter apparatus 9800 is mapped to one number or one role.

Among the six embodiments as shown in FIG. 8, the black and the while circles may represent the first and the second driving electrodes, respectively. In the six embodiments as shown in FIG. 8, lines 330A through 330F are lines between the first and the second driving electrodes, respectively. Length of the lines 330A through 330F are different from each other. Hence, the touch sensitive processing apparatus 9910 can determine which one of the contact surfaces touches the touch screen 9920 based on the length of the line. It can further calculate the central point or the representative point of the corresponding contact surface according to the central point of the first driving electrode and the central point of the second driving electrode. Moreover, the orientation of the active transmitter apparatus 9800 can be determined further. The embodiments of multiple contact surfaces as shown in FIG. 8 can belong to one single active transmitter apparatus 9800 or be applied to multiple active transmitter apparatuses 9800, respectively.

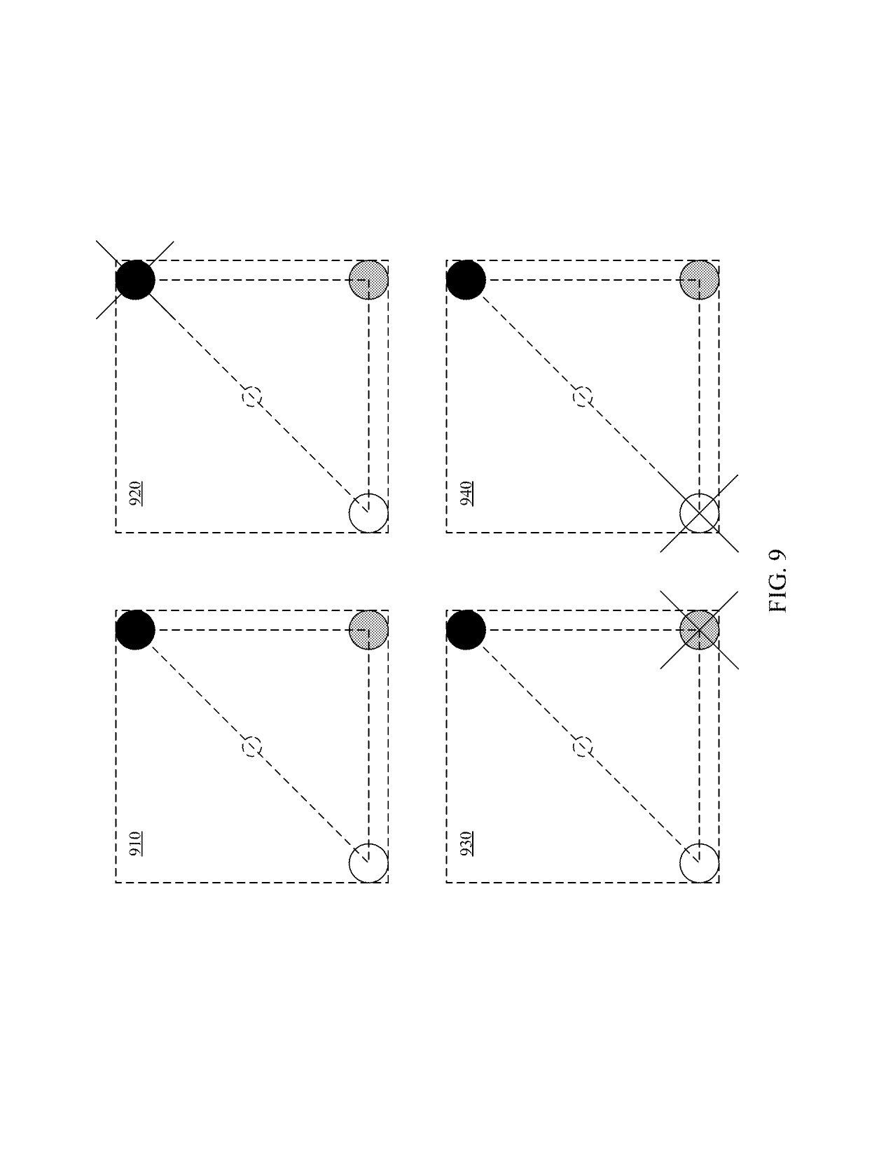

Please refer to FIG. 9, which is a diagram depicts a contact surface with three driving electrodes in accordance with an embodiment of the present application. In the embodiment as shown in FIG. 9, the contact surface may include three driving electrodes. It may be also to configure the signal transmissions of the active transmitter apparatus 9800 via the interface module 9840. For example, it may be configured as contact surface 910 in which all three driving electrodes are used to emit signals. The touch sensitive processing apparatus 9910 can recognize it as the first kind of contact surface 910. Since the positions of the three driving electrodes and distances between these three driving electrodes are well-known to the touch sensitive processing apparatus 9910, it is able to determine the orientation and the position of the representative point of the active transmitter apparatus 9800.

It may have three configurations, each has two of the three driving signals capable of emitting signals, respectively, as contact surfaces 920, 930, and 940. Since the touch sensitive processing apparatus 9910 knows the positions of the two driving electrodes and the distance between the two driving electrodes, it is able to determine the orientation and the position of the representative point of the active transmitter apparatus 9800. As a result, single one active transmitter apparatus 9800 can be configured as one of four roles.

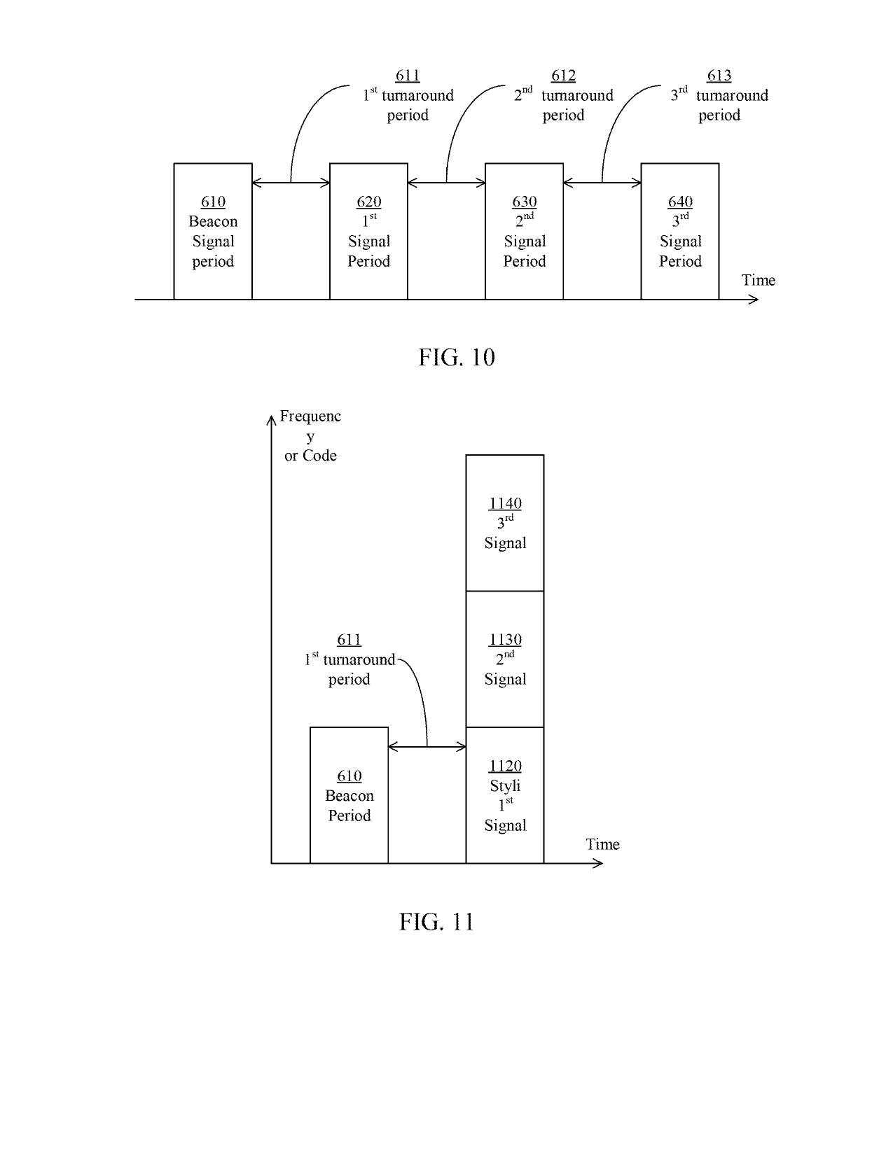

Please refer to FIG. 10, which is a timing diagram depicting beacon signals and signals transmitted by the active transmitter according to another embodiment of the present application. During one period, these three driving electrodes may emit signals during three signal time periods 631, 632, and 633. The touch sensitive processing apparatus 9910 may determine positions of these three driving electrodes during these three signal time periods 631, 632, and 633, respectively, and determine the configuration is the contact surface 910. When it does not receive signal during one of these three signal time periods, the touch sensitive processing apparatus 9910 can determine positions of the other two driving electrodes during the other two of the three signal time periods and determine the configuration is one of the contact surfaces 920-940. No matter two or three positions of the driving electrodes are detected, the touch sensitive processing apparatus 9910 can determine the orientation and the position of the representative point of the active transmitter apparatus 9800.

Please refer to FIG. 11, which is a timing diagram depicting beacon signals and signals transmitted by the active transmitter according to another embodiment of the present application. During one period, the three driving electrodes can be used to emit modulated signals with different frequencies or with different codes in the same signal time period 631, respectively. When the touch sensitive processing apparatus 9910 receives the modulated signals with three different frequencies or different codes, it can determine the positions of the three driving electrodes and determine the configuration is the contact surface 910. When the touch sensitive processing apparatus 9910 receives the modulated signals with two different frequencies or different codes, it can determine the positions of the two driving electrodes and determine the configuration is one of the contact surfaces 920~940. No matter positions of two or three contact surfaces are detected, the touch sensitive processing apparatus 9910 can calculate the orientation and the position of the representative point of the active transmitter apparatus 9800.

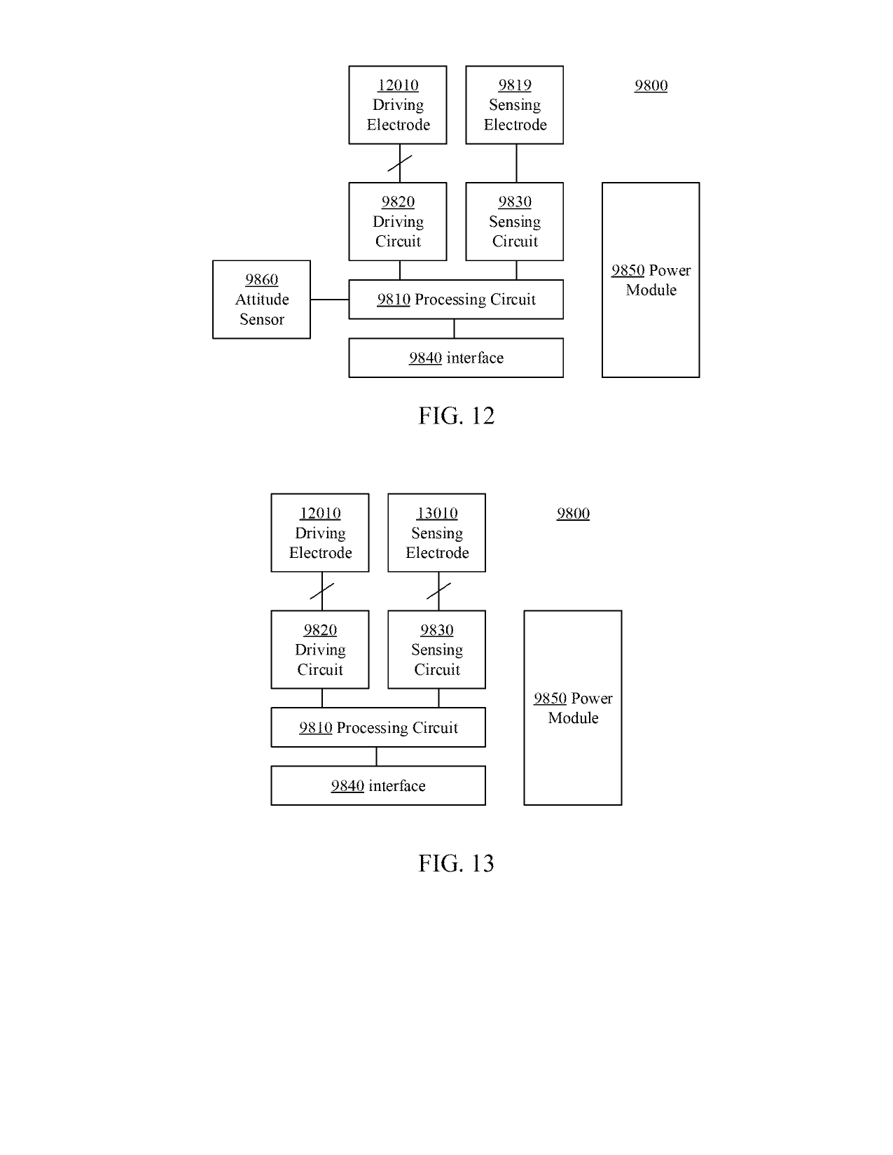

Please refer to FIG. 12, which shows a block diagram of a variant of the active transmitter apparatus 9800 as shown in FIG. 2. The active transmitter apparatus 9800 may include multiple contact surfaces. Each of the contact surfaces include at least two or more driving electrodes. The contact surfaces may be embodied as the contact surfaces as shown in FIGS. 8 or 9. In this embodiment, the driving electrodes are collectively named as driving electrodes 12010. The driving circuit module 9820 connects to each of driving electrodes 12010, respectively.

Comparing with the embodiment as shown in FIG. 2, the difference resides that the active transmitter apparatus 9800 may comprise attitude sensor 9860 for detecting which contact surface is downward. Accordingly, the processing circuit 9810 is able to only let the driving electrodes 12010 of the downward contact surface emit driving signals.

Please refer to FIG. 13, which shows a block diagram of a variant of the active transmitter apparatus 9800 as shown in FIG. 2. The active transmitter apparatus 9800 may include multiple contact surfaces. Each of the contact surfaces include at least two or more driving electrodes and at least one sensing electrode. In this embodiment, the driving electrodes are collectively named as driving electrodes 12010. The driving circuit module 9820 connects to each of driving electrodes 12010, respectively. The sensing electrodes are collectively named as sensing electrodes 13010. The sensing circuit module 9830 connects to the sensing electrodes 13010, respectively.

Comparing with the embodiment as shown in FIG. 2, the difference resides that the sensing circuit module 9830 of the active transmitter apparatus 9800 may be aware of which one of the sensing electrodes 13010 sense the beacon signals and its corresponding contact surface. In other words, the contact surface corresponding to the sensing electrode 13010 which senses the beacon signal touches the touch screen 9920. Accordingly, the processing circuit 9810 is able to only let the driving electrodes 12010 of the contact surface which senses the beacon signals emit driving signals.

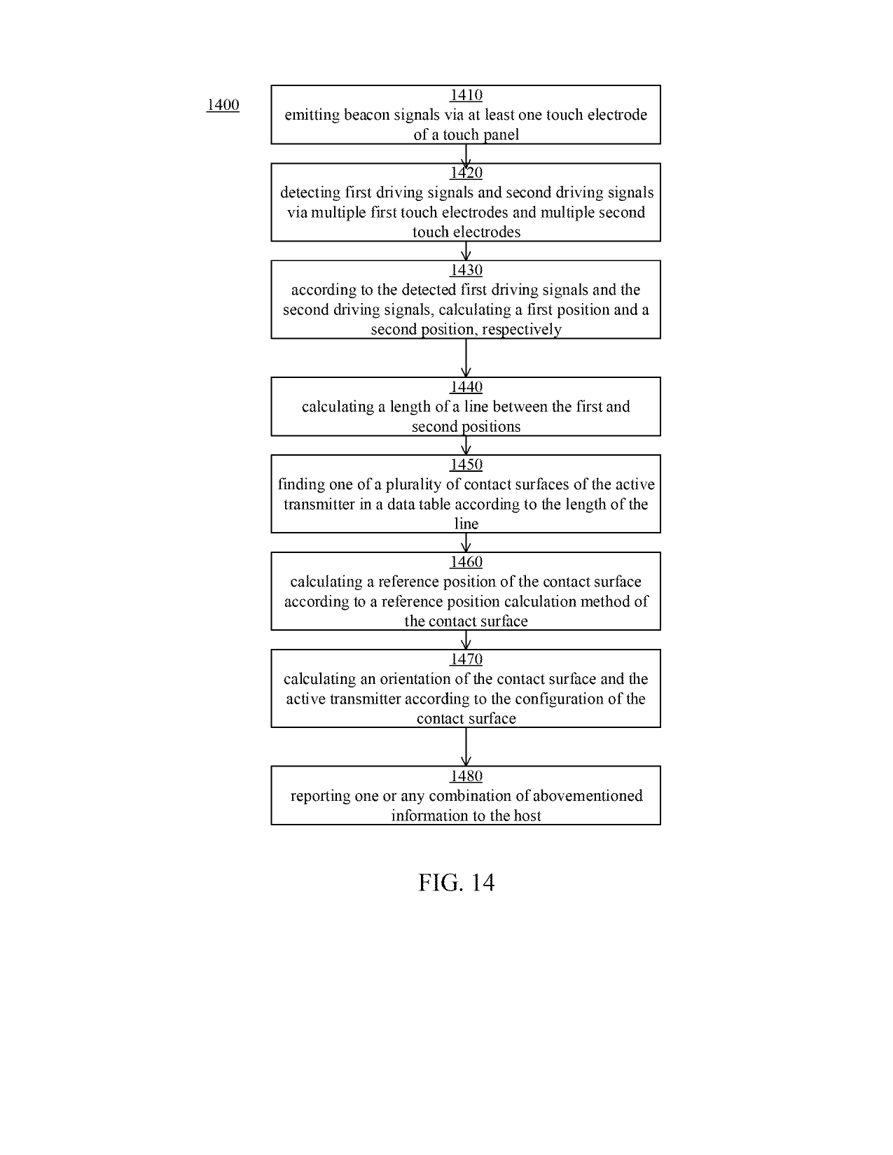

Please refer to FIG. 14, which depicts a flowchart diagram of a touch sensitive processing method 1400 in accordance with an embodiment of the present application. The touch sensitive processing method 1400 may be realized by the touch sensitive processing apparatus 9910 as shown in FIG. 1. Especially, the touch sensitive processing method 140 may be realized by the execution of multiple instructions stored in non-volatile memory by the processor module 9914. If there is no direct or indirect causal relationship between any two steps, the present application does not limit the execution sequence of these two steps. The touch sensitive processing method 1400 may begin at step 1410 or at step 1420.

Optional step 1410: emitting beacon signals via at least one touch electrode of a touch panel. The beacon signals may be driving signals used by the touch sensitive processing apparatus 9910 for detecting a finger, the stylus 9930, or the touch eraser 9935. The beacon signals may be specific signals used for triggering one or more active transmitters 9800.

Step 1420: after the beacon signals are emitted, detecting first driving signals and second driving signals via multiple first touch electrodes and multiple second touch electrodes of the touch panel, respectively. The first driving signals are emitted from a first driving electrode 9811 of the active transmitter 9800. The second driving signals are emitted from a second driving electrode 9812 of the active transmitter 9800. The result of detections is in a form of two arrays of detected signals.

Step 1430: according to the detected first driving signals and the second driving signals, calculating a first position and a second position, respectively, which are corresponding to the first driving electrode 9811 and the second electrode 9812. The step may be based on the two arrays of detected signals. Furthermore, the detected signals may be demodulated according to the modulations of the transmitted signals. The first and the second driving signals may be modulated according to one or any combination of following: time, frequency, code, phase, and ratio of signal strength.

Step 1440: calculating a length of a line between the first and second positions.

Step 1450: finding one of a plurality of contact surfaces of the active transmitter in a data table according to the length of the line. Because the lengths of the lines correspond to each contact surfaces are different, the data table includes multiple lengths of the lines and their corresponding contact surfaces.

Step 1460: calculating a reference position of the contact surface according to a reference position calculation method of the contact surface. Because the configurations of the first driving electrode 9811 and the second driving electrode 9812 of each contact surfaces are different, a reference position of the contact surface may be calculated according to the reference position calculation method and the corresponding first and the second positions. In the embodiments as shown in FIG. 8, the correspondences between the reference positions and their first driving electrodes 9811 and second driving electrodes 9812 can be found.

Step 1470: calculating an orientation of the contact surface and the active transmitter according to the configuration of the contact surface. A shape being formed by the reference position, the first driving electrode 9811, and the second driving electrode 9812 may be calculated based on the configuration of the contact surface. The orientation of the contact surface and the active transmitter can be found accordingly.

Step 1480: reporting one or any combination of abovementioned information to the host 9940 by the interface module 9915.

According to an embodiment of the present application, an active transmitter is provided. The active transmitter, comprising: multiple contact surfaces, each of the contact surfaces comprises a first driving electrode and a second driving electrode, there is a line between the first and the second driving electrodes, wherein lengths of the lines corresponding to the contact surfaces are different.

Preferably, in order to calculate a reference position of the one of the contact surfaces, wherein the active transmitter emits a first and a second driving signals via the first and the second driving electrodes of at least one of the contact surfaces, respectively, such that a touch sensitive processing apparatus of a touch panel is aware of positions of the first and the second driving electrodes on the touch panel according to the first and the second driving signals, respectively, a length of the line between the first and the second driving electrodes, and the at least one contact surfaces corresponding to the length of the line, and an orientation of the active transmitter accordingly.

Preferably, in order to distinguish the first and the second driving signals by the touch sensitive processing apparatus, wherein the first and the second driving signals are modulated according to one or any combination of following modulations: time, frequency, code, phase, and ratio of signal strength.

Preferably, in order to make the active transmitter as a toss tool, wherein the contact surfaces comprise N contact surfaces, size and shape of each of the contact surfaces are identical, the active transmitter is N-sided polyhedron, where N is a positive integer equals or larger than 4.

Preferably, in order to let the touch sensitive processing apparatus detect the active transmitter via the touch panel, the active transmitter is further configured for emitting first driving signals via the first driving electrodes of every of the contact surfaces and emitting second driving signals via the second driving electrodes of every of the contact surfaces.

Preferably, in order to saving power consumption of the active transmitter and reducing interference to the touch sensitive processing apparatus, wherein the active transmitter further comprises a sensing electrode, wherein the active transmitter is configured for emitting the first and the second driving signals after detecting, by the sensing electrode, beacon signals being periodically emitted by the touch sensitive processing apparatus.

Preferably, in order to saving power consumption of the active transmitter and reducing interference to the touch sensitive processing apparatus, wherein each of the contact surfaces comprises a sensing electrode, wherein the active transmitter is configured for emitting the first and the second driving signals via the first and the second driving electrodes of a first contact surface of the contact surfaces, respectively, after detecting, by the sensing electrode of the first contact surface, beacon signals being periodically emitted by the touch sensitive processing apparatus.

Preferably, in order to saving power consumption of the active transmitter, wherein the active transmitter further comprises an attitude sensor for sensing a first contact surface of the contact surfaces corresponding to a touch panel, wherein the active transmitter is configured to emit the first and the second driving signals only via the first and the second driving electrodes of the first contact surface, respectively.

Preferably, in order to increase the number of contact surfaces, wherein a first contact surfaces of the contact surfaces comprises a third driving electrode, wherein the active transmitter is configured for emitting driving signals via the first, the second, and the third driving electrodes of the first contact surface such that a touch sensitive processing apparatus of a touch panel is aware of positions of the first, the second, and the third driving electrodes on the touch panel according to the driving signals, respectively, and the first contact surfaces touching the touch panel.

Preferably, in order to increase the number of contact surfaces, wherein each of the contact surfaces comprises P driving electrodes, where P is a positive integer larger than 2, wherein the active transmitter further comprises an interface module configured for receiving a configuration command for setting shapes being formed by Q driving electrodes capable of emitting driving signals of the contact surfaces, wherein the shapes of the contact surfaces are different, where Q is a positive integer equals to or smaller than P.

According to an embodiment of the present application, a touch sensitive processing apparatus is provided for connecting to a touch panel for detecting a first active transmitter, wherein the touch panel comprising multiple first touch electrodes in parallel to a first axis and multiple second touch electrodes in parallel a second axis, each of the first electrodes intersects with the second touch electrodes, wherein the touch sensitive processing apparatus comprising: an interconnection network module for connecting to the first and the second touch electrodes, respectively; a sensing circuit module for connecting to the interconnection module for receiving first driving signals and second driving signals from a first contact surface of multiple contact surfaces of the first active transmitter via the first and the second touch electrodes, respectively; a processor module for executing instructions stored in non-volatile memory for realizing: calculating a first and a second positions of the first and the second driving electrodes on the touch panel according to the first and the second driving signals, respectively, calculating a length of a first line between the first and the second positions, and finding the first contact surfaces among the contact surfaces corresponding to the length of the first line in a data table; and an interface module for reporting the first contact surfaces of the first active transmitter to a host.

Preferably, in order to report a reference position where the first active transmitter on the touch panel, wherein the processor module is further configured for calculating a first reference position of the first active transmitter on the touch panel according to a reference position calculation method corresponding to the first contact surface and the first and the second positions; and the interface module is further configured for reporting the first reference position of the first active transmitter to the host.

Preferably, in order to report an orientation of the first active transmitter on the touch panel, wherein the processor module is further configured to calculate an orientation of the first active transmitter on the touch panel according to a configuration of the first and the second driving electrodes corresponding to the first contact surface and the first and the second positions, and wherein the interface module is further configured for reporting the orientation of the first active transmitter to the host.

Preferably, in order to distinguish the first and the second driving signals by the touch sensitive processing apparatus, wherein the first and the second driving signals are modulated according to one or any combination of following modulations: time, frequency, code, phase, and ratio of signal strength, wherein the processor module is configured to demodulate the received first and the second driving signals according to the modulations.

Preferably, in order to saving power consumption of the active transmitter and reducing interference to the touch sensitive processing apparatus, wherein the touch sensitive processing apparatus further comprises a driving circuit module for connecting the interconnection network module to periodically emit beacon signals via at least one of the first touch electrode or at least one of the second touch electrode in a first signal period, wherein the sensing circuit module is configured to periodically sense the first and the second driving signals in a second signal period after the first signal period.

Preferably, in order to increase the number of contact surfaces, wherein the first contact surface further comprises a third driving electrode, wherein the active transmitter is configured for emitting driving signals via the first, the second, and the third driving electrodes of the first contact surface, wherein the sensing circuit module is configured to sense the driving signals, wherein the processor module is configured to calculate positions of the first, the second, and the third driving electrodes on the touch panel according to the driving signals, respectively; and to determine that the first contact surface touching the touch panel according to the data table.

Preferably, in order to increase the number of contact surfaces, wherein the data table further comprises a shape being formed by the first, the second, and the third driving electrodes.

Preferably, in order to increase the number of active transmitters being used simultaneously, wherein the sensing circuit module for connecting to the interconnection module for receiving third driving signals and fourth driving signals emitted from the first driving electrode and the second electrode of a second contact surface of multiple contact surfaces of a second active transmitter via the first and the second touch electrodes, respectively; wherein the processor module is further configured for calculating a third and a fourth positions of the first and the second driving electrodes on the touch panel according to the third and the fourth driving signals, respectively, calculating a length of a second line between the third and the fourth positions, and finding the second contact surface among the contact surfaces corresponding to the length of the second line in the data table; and wherein the interface module is further configured for reporting second first contact surfaces of the second active transmitter to the host, wherein the first and the second active transmitters are in the same kind.

According to an embodiment of the present application, a touch system is provided. The touch system comprises the first active transmitter, the touch panel, the touch sensitive processor, and the host.

According to an embodiment of the present application a touch sensitive processing method for detecting a first active transmitter via a touch panel is provided. The touch panel comprising multiple first touch electrodes in parallel to a first axis and multiple second touch electrodes in parallel a second axis, each of the first electrodes intersects with the second touch electrodes. The touch sensitive processing method comprising: sensing first and second driving signals via first and second touch electrodes of the touch panel, wherein the first driving signals are emitted from a first driving electrode of the first active transmitter and the second driving signals are emitted from a second driving electrode of the first active transmitter; calculating a first position and a second position according to the sensed first driving signals and the sensed driving signals, respectively, wherein the first and the second positions are corresponding to the first and the second driving electrodes, respectively; calculating a length of a line between the first and the second positions; finding a first contact surface among multiple contact surfaces of the first active transmitter in a data table according to the length of the line, wherein the contact surface comprises the first and the second driving electrodes; and reporting to a host that the first contact surface of the first active transmitter touching the touch panel.

Preferably, in order to report a reference position where the first active transmitter on the touch panel, wherein the touch sensitive processing method further comprises: calculating a first reference position of the first active transmitter on the touch panel according to a reference position calculation method corresponding to the first contact surface and the first and the second positions; and reporting the first reference position of the first active transmitter to the host.

Preferably, in order to obtain an orientation of the active transmitter with respect to the touch panel, wherein the touch sensitive processing method further comprises: calculating an orientation of the first active transmitter according to a configuration of the first and the second driving electrodes corresponding to the first contact surface and the first and the second positions; and reporting the orientation of the first active transmitter to the host.

Preferably, in order to distinguish the first and the second driving signals by the touch sensitive processing apparatus, wherein the first and the second driving signals are modulated according to one or any combination of following modulations: time, frequency, code, phase, and ratio of signal strength, wherein the step of calculating the first position and a second position includes demodulations according to the modulations.

Preferably, in order to saving power consumption of the active transmitter and reducing interference to other kinds of touch sensing, wherein the touch sensitive processing method further comprises periodically emitting beacon signals via at least one of the first touch electrode or at least one of the second touch electrode in a first signal period; and periodically sensing the first and the second driving signals in a second signal period after the first signal period.

Preferably, in order to increase the number of contact surfaces, wherein the active transmitter is configured for emitting driving signals via the first, the second, and the third driving electrodes of the first contact surface, wherein the touch sensitive processing method further comprises sensing the driving signals; calculating positions of the first, the second, and the third driving electrodes on the touch panel according to the driving signals, respectively; and determining that the first contact surface touching the touch panel according to the data table.

Preferably, in order to increase the number of contact surfaces, wherein the data table further comprises a shape being formed by the first, the second, and the third driving electrodes.

Preferably, in order to increase the number of active transmitters being used simultaneously, the touch sensitive processing method further comprises: receiving third driving signals and fourth driving signals emitted from the first driving electrode and the second electrode of a second contact surface of multiple contact surfaces of a second active transmitter via the first and the second touch electrodes, respectively; calculating a third and a fourth positions of the first and the second driving electrodes on the touch panel according to the third and the fourth driving signals, respectively; calculating a length of a second line between the third and the fourth positions; finding the second contact surfaces among the contact surfaces corresponding to the length of the second line in the data table; and reporting second first contact surfaces of the second active transmitter to the host, wherein the first and the second active transmitters are in the same kind.

According to one or more active transmitters provided by the present application, multiple parameters can be simultaneously inputted into a touch panel or a touch screen. Thus, the touch sensitive processing apparatus of the touch panel is able to aware of positions and orientations of the one or more active transmitters. Moreover, it can further determine that which contact surfaces of each of the active transmitters are used to input into the touch panel and corresponds to which one of different roles, numbers, characters, or pieces of games.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An active transmitter, comprising:
multiple contact surfaces, each of the contact surfaces comprises a first driving electrode and a second driving electrode, there is a line between the first and the second driving electrodes,
wherein lengths of the lines corresponding to the contact surfaces are different.

2. The active transmitter as recited in claim 1, wherein the active transmitter emits a first and a second driving signals via the first and the second driving electrodes of at least one of the contact surfaces, respectively, such that a touch sensitive processing apparatus of a touch panel is aware of
positions of the first and the second driving electrodes on the touch panel according to the first and the second driving signals, respectively,
a length of the line between the first and the second driving electrodes,
the at least one contact surfaces corresponding to the length of the line, and
an orientation of the active transmitter accordingly.

3. The active transmitter as recited in claim 1, wherein the first and the second driving signals are modulated according to one or any combination of following modulations: time, frequency, code, phase, and ratio of signal strength.

4. The active transmitter as recited in claim 1, wherein the contact surfaces comprise N contact surfaces, size and shape of each of the contact surfaces are identical, the active transmitter is N-sided polyhedron, where N is a positive integer equals or larger than 4.

5. The active transmitter as recited in claim 1, further configured for emitting first driving signals via the first driving electrodes of every of the contact surfaces and emitting second driving signals via the second driving electrodes of every of the contact surfaces.

6. The active transmitter as recited in claim 2, further comprises a sensing electrode, wherein the active transmitter is configured for emitting the first and the second driving signals after detecting, by the sensing electrode, beacon signals being periodically emitted by the touch sensitive processing apparatus.

7. The active transmitter as recited in claim 2, further comprises a sensing electrode, wherein each of the contact surfaces comprises a sensing electrode, wherein the active transmitter is configured for emitting the first and the second driving signals via the first and the second driving electrodes of a first contact surface of the contact surfaces, respectively, after detecting, by the sensing electrode of the first contact surface, beacon signals being periodically emitted by the touch sensitive processing apparatus.

8. The active transmitter as recited in claim 1, further comprises an attitude sensor for sensing a first contact surface of the contact surfaces corresponding to a touch panel, wherein the active transmitter is configured to emit the first and the second driving signals only via the first and the second driving electrodes of the first contact surface, respectively.

9. The active transmitter as recited in claim 1, wherein a first contact surfaces of the contact surfaces comprises a third driving electrode, wherein the active transmitter is configured for emitting driving signals via the first, the second, and the third driving electrodes of the first contact surface such that a touch sensitive processing apparatus of a touch panel is aware of positions of the first, the second, and the third driving electrodes on the touch panel according to the driving signals, respectively, and the first contact surfaces touching the touch panel.

10. The active transmitter as recited in claim 1, each of the contact surfaces comprises P driving electrodes, where P is a positive integer larger than 2, wherein the active transmitter further comprises an interface module configured for receiving a configuration command for setting shapes being formed by Q driving electrodes capable of emitting driving signals of the contact surfaces, wherein the shapes of the contact surfaces are different, where Q is a positive integer equals to or smaller than P.

11. A touch sensitive processing apparatus for connecting to a touch panel for detecting a first active transmitter, wherein the touch panel comprising multiple first touch electrodes in parallel to a first axis and multiple second touch electrodes in parallel a second axis, each of the first electrodes intersects with the second touch electrodes, wherein the touch sensitive processing apparatus comprising:
an interconnection network module for connecting to the first and the second touch electrodes, respectively;
a sensing circuit module for connecting to the interconnection module for receiving first driving signals and second driving signals from a first contact surface of multiple contact surfaces of the first active transmitter via the first and the second touch electrodes, respectively;
a processor module for executing instructions stored in non-volatile memory for realizing:
calculating a first and a second positions of the first and the second driving electrodes on the touch panel according to the first and the second driving signals, respectively;
calculating a length of a first line between the first and the second positions; and
finding the first contact surfaces among the contact surfaces corresponding to the length of the first line in a data table; and
an interface module for reporting the first contact surfaces of the first active transmitter to a host.

12. The touch sensitive processing apparatus as recited in claim 11,
wherein the processor module is further configured for calculating a first reference position of the first active transmitter on the touch panel according to a reference position calculation method corresponding to the first contact surface and the first and the second positions; and
the interface module is further configured for reporting the first reference position of the first active transmitter to the host.

13. The touch sensitive processing apparatus as recited in claim 11,
wherein the processor module is further configured to calculate an orientation of the first active transmitter on the touch panel according to a configuration of the first and the second driving electrodes corresponding to the first contact surface and the first and the second positions, and
wherein the interface module is further configured for reporting the orientation of the first active transmitter to the host.

14. The touch sensitive processing apparatus as recited in claim 11, wherein the first and the second driving signals are modulated according to one or any combination of following modulations: time, frequency, code, phase, and ratio of signal strength, wherein the processor module is configured to demodulate the received first and the second driving signals according to the modulations.

15. The touch sensitive processing apparatus as recited in claim 11, further comprises
a driving circuit module for connecting the interconnection network module to periodically emit beacon signals via at least one of the first touch electrode or at least one of the second touch electrode in a first signal period,
wherein the sensing circuit module is configured to periodically sense the first and the second driving signals in a second signal period after the first signal period.

16. The touch sensitive processing apparatus as recited in claim 11,
wherein the first contact surface further comprises a third driving electrode,
wherein the active transmitter is configured for emitting driving signals via the first, the second, and the third driving electrodes of the first contact surface,
wherein the sensing circuit module is configured to sense the driving signals,
wherein the processor module is configured to calculate positions of the first, the second, and the third driving electrodes on the touch panel according to the driving signals, respectively; and to determine that the first contact surface touching the touch panel according to the data table.

17. The touch sensitive processing apparatus as recited in claim 16, wherein the data table further comprises a shape being formed by the first, the second, and the third driving electrodes.

18. The touch sensitive processing apparatus as recited in claim 11,
wherein the sensing circuit module for connecting to the interconnection module for receiving third driving signals and fourth driving signals emitted from the first driving electrode and the second electrode of a second contact surface of multiple contact surfaces of a second active transmitter via the first and the second touch electrodes, respectively;
wherein the processor module is further configured for calculating a third and a fourth positions of the first and the second driving electrodes on the touch panel according to the third and the fourth driving signals, respectively, calculating a length of a second line between the third and the fourth positions, and finding the second contact surface among the contact surfaces corresponding to the length of the second line in the data table; and
wherein the interface module is further configured for reporting second first contact surfaces of the second active transmitter to the host, wherein the first and the second active transmitters are in the same kind.

19. A touch system comprises the first active transmitter, the touch panel, the touch sensitive processor, and the host as recited in claim 11.

20. A touch sensitive processing method for detecting a first active transmitter via a touch panel, wherein the touch panel comprising multiple first touch electrodes in parallel to a first axis and multiple second touch electrodes in parallel a second axis, each of the first electrodes intersects with the second touch electrodes, wherein the touch sensitive processing method comprising:
sensing first and second driving signals via first and second touch electrodes of the touch panel, wherein the first driving signals are emitted from a first driving electrode of the first active transmitter and the second driving signals are emitted from a second driving electrode of the first active transmitter;
calculating a first position and a second position according to the sensed first driving signals and the sensed driving signals, respectively, wherein the first and the second positions are corresponding to the first and the second driving electrodes, respectively;
calculating a length of a line between the first and the second positions; finding a first contact surface among multiple contact surfaces of the first active transmitter in a data table according to the length of the line, wherein the contact surface comprises the first and the second driving electrodes; and
reporting to a host that the first contact surface of the first active transmitter touching the touch panel.

21. The touch sensitive processing method as recited in claim 20, further comprises:
calculating a first reference position of the first active transmitter on the touch panel according to a reference position calculation method corresponding to the first contact surface and the first and the second positions; and
reporting the first reference position of the first active transmitter to the host.

22. The touch sensitive processing method as recited in claim 20, further comprises:
calculating an orientation of the first active transmitter according to a configuration of the first and the second driving electrodes corresponding to the first contact surface and the first and the second positions; and
reporting the orientation of the first active transmitter to the host.

23. The touch sensitive processing method as recited in claim 20,
wherein the first and the second driving signals are modulated according to one or any combination of following modulations: time, frequency, code, phase, and ratio of signal strength,
wherein the step of calculating the first position and a second position includes demodulations according to the modulations.

24. The touch sensitive processing method as recited in claim 20, further comprises:
periodically emitting beacon signals via at least one of the first touch electrode or at least one of the second touch electrode in a first signal period; and
periodically sensing the first and the second driving signals in a second signal period after the first signal period.

25. The touch sensitive processing method as recited in claim 20,
wherein the active transmitter is configured for emitting driving signals via the first, the second, and the third driving electrodes of the first contact surface,
wherein the touch sensitive processing method further comprises
sensing the driving signals;
calculating positions of the first, the second, and the third driving electrodes on the touch panel according to the driving signals, respectively; and
determining that the first contact surface touching the touch panel according to the data table.

26. The touch sensitive processing method as recited in claim 25, wherein the data table further comprises a shape being formed by the first, the second, and the third driving electrodes.

27. The touch sensitive processing method as recited in claim 20, further comprises:
receiving third driving signals and fourth driving signals emitted from the first driving electrode and the second electrode of a second contact surface of multiple contact surfaces of a second active transmitter via the first and the second touch electrodes, respectively;
calculating a third and a fourth positions of the first and the second driving electrodes on the touch panel according to the third and the fourth driving signals, respectively;
calculating a length of a second line between the third and the fourth positions; finding the second contact surfaces among the contact surfaces corresponding to the length of the second line in the data table; and
reporting second first contact surfaces of the second active transmitter to the host,
wherein the first and the second active transmitters are in the same kind.
